(19) United States
(12) Patent Application Publication
(10) Pub. No.: US 2008/0200611 A1
(43) Pub. Date: Aug. 21, 2008

(54) Blends of Ethylene Acrylate Copolymers With Ethylene Based Wax For Asphalt Modification

(76) Inventors: George Wyatt Prejean, Orange, TX (US); Gregg Byron Babcock, Wilmington, DE (US)

Correspondence Address: Bromels, Marilyn H.;E.I. Du Pont De Nemours and Company, Legal Patent Records Center, 4417 Lancaster Pike, Wilmington, DE, 19805, US

(21) Appl. No.: 11/884,816

(22) PCT Filed: Apr. 4, 2006
(86) PCT No.: PCT/US2006/012399

§ 371 Date: Aug. 20, 2007

Related U.S. Application Data
(60) Provisional application No. 60/668,158, filed on Apr. 4, 2005.
(60) Provisional application No. 60/668,119, filed on Apr. 4, 2005.

(51) Int. Cl. C08L 33/02

(52) U.S. Cl. 525/52; 525/221

(57) ABSTRACT

Polymer-modified asphalt compositions comprising an elastomeric ethylene copolymer and a low molecular weight plastomer and asphalt demonstrate excellent elasticity and stiffness.

### FIELD OF THE INVENTION

The present invention relates to modified asphalt compositions. The present invention particularly relates to polymer-modified asphalt compositions comprising ethylene copolymers and a low molecular weight polyolefin wax.

### BACKGROUND OF THE INVENTION

Asphalt is material obtained from the distillation bottoms of petroleum products, and is used extensively for paving roads, highways, parking lots, playgrounds, and other areas where smooth passage of pedestrian or vehicular traffic is desirable. Asphalt is generally blended with rock to obtain a composite paving composition that is used for paving. While rock is typically the major portion of the paving composition, generally as much as 95 wt. % of the composition, the asphalt makes important contributions to the properties to the mixture.

Asphalt can be considered as an adhesive or binder composition that serves the purpose of holding the rock (aggregate) together. At the same time, asphalt provides elasticity so that the pavement can regain its original shape after deformation under the weight of traffic. While elasticity is an important property imparted by the asphalt, the asphalt should not be so elastic that the pavement loses stiffness.

Asphalt can be modified with polymers to improve certain properties, including rut resistance, fatigue resistance and cracking resistance. The presence of the modifying polymer can also improve stripping resistance (from aggregate) in paving. These improvements result from increases in asphalt elasticity and stiffness and both improvements can be the result of polymer addition.

A set of specifications developed by the federal government (Strategic Highway Research Program or SHRP) is used in grading performance of asphalt. For example, a PG58-34 asphalt should provide good rut resistance at 58° C. and good cold cracking resistance at −34° C. The asphalt is considered a PG 58 grade. Addition of polymer to asphalt significantly increases the higher number (i.e. provides higher temperature rut resistance) and significantly improves fatigue resistance. The improvements in rut and fatigue resistance result from increases in stiffness and elasticity. These increases are effected by the addition of relatively small amounts of polymer, generally 1 to 5 wt. %. Elasticity of asphalt is determined by measuring the phase angle using a dynamic shear rheometer and measuring elastic recovery. Asphalt stiffness is measured using a dynamic shear rheometer (DSR). Details of the test are described in TP5 of AASHTO (American Association of State Highway Transportation Officials). The actual measurement used is G*/sin d, which is the complex modulus divided by the phase angle. The value of G*/sin d is 1 or higher at 58° C. for a PG 58 grade asphalt. Asphalts are graded in 6° C. increments, for example PG58, PG64, PG70, and PG76. The value G*/sin d for a given PG grade can exceed 1. For example a PG 58 asphalt might have a value of 1.5 at 58° C., but it is still a PG 58 grade until the value of G*/sin d is measured to be 1 at 64° C. If such were the case, the asphalt would then be classified as a PG 64 asphalt. Occasionally PG values are reported as pass/fail. An example of this would be a PG 58 asphalt with a G*/sin d value of 1.5. It might be reported as a PG pass/fail of 59.9. Elastic recovery (ER) is measured using a ductilometer. A “dogbone” sample of the asphalt is elongated to 10 cm, cut in the center and the % recovery after one hour determined. The test is normally conducted at 25° C. according to the provisions of ASTM D6084.

A wide variety of ethylene alkyl ester copolymers are known as modifiers for asphalt. German patent 1,644,771 discloses and claims bitumen compositions made up of from 5 to 95 wt. % aromatic petroleum asphalt and from 95 to 5 wt. % of an ethylene/acrylate ester copolymer. The copolymer fraction is either an ethylene/alkyl acrylate or ethylene/alkyl methacrylate copolymer derived from copolymerization of ethylene and from 1 to 40 wt. % of alkyl acrylate or alkyl methacrylate ester, wherein the alkyl group contains from 1 to 8 carbon atoms.

In U.S. Pat. Nos. 5,306,700 and 5,556,900 compositions useful in road paving and roofing applications are disclosed that include a reactive polymeric asphalt additive that chemically reacts with and links to the asphalt as a result of the presence of an epoxy functional group. The reactive polymer additive is an ethylene copolymer of the general formula E/X/Y/Z where E represents the ethylene derived unit and constitutes from 20 to 99.5 wt. % of the copolymer. The X comonomer can be present in amounts of up to 50 wt. % and is for example, an alkyl acrylate, alkyl methacrylate, vinyl ester or alkyl vinyl ether. The Y comonomer is present in amounts of from 0.5 to 15 wt. % and is for example, glycidyl acrylate, glycidyl methacrylate or glycidyl vinyl ether. The Z comonomer is optionally present in amounts of up to 15 wt. % and is a monomer such as carbon monoxide, sulfur dioxide, acrylonitrile and the like. Of particular note is the reactive terpolymer ethylene/n-butyl acrylate/glycidyl methacrylate (EnBAGMA), which is known (after chemical linking to the asphalt) to significantly improve both elasticity and stiffness of the resulting modified asphalt product.

In U.S. Pat. Nos. 6,117,926 and 6,399,680 improved polymer-modified asphalt compositions are taught wherein an asphalt and a stiffness-enhancing copolymer having available epoxy groups are reacted in the presence of an effective amount of an acid (e.g., H₃PO₄ and H₂SO₄) to promote chemical bonding between the asphalt and the available epoxy groups of the copolymer. The use of the acid is shown to minimize the amount of epoxy functionalized polymer additive required to achieve greater stiffness values. The references also disclose that asphalt compositions having good low temperature performance are attained by the addition of processing oils. Additionally, ethylene copolymers including ethylene vinyl acetate, ethylene methyl acrylate, ethylene n-butyl acrylate, and ethylene ethyl acrylate copolymers may be blended with the polymers. In U.S. Pat. Nos. 6,011,095 and 6,414,056 the specific use of polyphosphoric acid (PPA) and/or superphosphoric acid (SPA) as the acid adjuvant in the promotion of the chemical bonding between asphalt and the available epoxy groups of ethylene/methyl acrylate/glycidyl methacrylate terpolymer (EMAGMA) and ethylene/n-butyl acrylate/glycidyl methacrylate terpolymer (EnBAGMA) are exemplified, respectively.

Polymers typically will not have a pronounced effect on low temperature properties of asphalt. Good low temperature properties for asphalt are generally obtained by addition of oils such as gas oil. Plastomers such as polyethylene generally have an adverse effect on the low temperature properties of asphalt. In contrast, elastomers are generally considered to be desirable additives for asphalt. For a variety of reasons, the word “plastomer” has come to have a negative connotation in the asphalt industry, and to indicate a lack of elastomeric properties. Plastomers have occasionally been used to modify asphalt because they can increase stiffness and viscosity and thereby improve rut resistance. However, they are generally considered inferior additives compared to elastomers due to lack of significant improvements in asphalt fatigue resistance, creep resistance and cold crack resistance when plastomers are used.

As described above, ethylene/butyl acrylate/glycidyl methacrylate terpolymer (EnBAGMA) can be used for asphalt modification. EnBAGMA imparts significant elastomeric properties after it has reacted with the asphalt and is considered an elastomer. EnBAGMA (commercially available from E.I. du Pont de Nemours and Company under the tradename of Elvaloy® RET) is an excellent modifier for asphalt and significantly improves asphalt performance at low concentrations (1 wt. % to 2 wt. %).

Ethylene acrylates sold commercially by DuPont under the tradename of Elvaloy® AC, and blends of Elvaloy® AC with Elvaloy® RET, have been used as elastomeric resins for asphalt modification. Tubular ethylene acrylates have also surprisingly been found to impart good elastomeric properties to asphalt, while autoclave-produced ethylene acrylates behave as less desirable plastomers.

Although these prior art compositions exhibit desirable elastomeric properties in many instances, the properties are not optimum under all environmental conditions. A need exists for a wider variety of alternative modified asphalt conditions having a combination of desirable properties and which may be produced economically.

### SUMMARY OF THE INVENTION

In one aspect, the present invention is a composition useful as an asphalt modifier comprising an elastomer and a low molecular weight plastomer, wherein said elastomer is selected from the group consisting of ethylene/n-butyl acrylate/glycidyl methacrylate terpolymers, ethylene alkyl acrylate copolymers obtained by a tubular reactor process and mixtures thereof.

In another aspect, the present invention is a polymer-modified asphalt composition comprising an un-modified asphalt, an elastomer and a low molecular weight plastomer, wherein the elastomer is selected from the group consisting of ethylene/n-butyl acrylate/glycidyl methacrylate terpolymers, ethylene alkyl acrylate copolymers obtained by a tubular reactor process and mixtures thereof.

In another aspect, the present invention is a pavement comprising a polymer-modified asphalt composition wherein the polymer-modified asphalt composition comprises an un-modified asphalt, an elastomer and a low molecular weight plastomer, wherein the elastomer is selected from the group consisting of ethylene/n-butyl acrylate/glycidyl methacrylate terpolymers, ethylene alkyl acrylate copolymers obtained by a tubular reactor process and mixtures thereof.

In still another aspect, the present invention is a process for modifying an asphalt composition comprising the step of blending (i) a composition comprising an elastomer and a low molecular weight plastomer with (ii) an un-modified asphalt composition, wherein the elastomer is selected from the group consisting of ethylene/n-butyl acrylate/glycidyl methacrylate terpolymers, ethylene alkyl acrylate copolymers obtained by a tubular reactor process and mixtures thereof.

### DETAILED DESCRIPTION OF THE INVENTION

In one embodiment, the present invention is a composition comprising an elastomer and a plastomer, wherein the elastomer/plastomer composition can be useful in an asphalt composition. To determine whether the elastomer/plastomer composition is suitable for use in an asphalt composition, the composition can be graded using the SHRP specifications to determine whether the asphalt would provide suitable properties in a pavement. For example, a suitable composition should provide acceptable rut resistance at 58° C. and good cold cracking resistance at −34° C. for a specific geographic location. A warmer climate location might require acceptable rut resistance at 76° C. and only require good cold crack resistance at −22° C. At the same time, a suitable composition should provide acceptable fatigue resistance.

Elastomers suitable for use in preparing the elastomer/plastomer composition of the invention include certain copolymers of ethylene and alkyl acrylates. For example, alkyl acrylates that are esters of acrylic acid and C₁ to C₁₀ alcohols are suitable as comonomers. These include alkyl acrylates such as n-butyl acrylate, ethyl acrylate and methyl acrylate, which can easily be copolymerized with ethylene to provide the ethylene alkyl acrylate copolymers useful herein. Ethylene/n-butyl acrylate/glycidyl methacrylate terpolymers (EnBAGMA) are preferred. Ethylene alkyl acrylate copolymers sold commercially by E.I. du Pont de Nemours and Company (DuPont) under the tradename of Elvaloy® AC, and blends of Elvaloy® AC with Elvaloy® RET, can also be useful in the practice of the present invention. Such copolymers are produced by high pressure free radical copolymerization processes. Additionally, tubular ethylene alkyl acrylate copolymers can be useful in the practice of the present invention.

The tubular reactor produced ethylene/alkyl acrylate copolymers useful in the present invention are ethylene copolymers derived from the copolymerization of ethylene monomer and at least one alkyl acrylate or alkyl methacrylate comonomer, wherein the alkyl group contains from 1 to 8 carbon atoms. Such polymers are described in pending U.S. patent application Ser. No. 10/806,559. More specifically, the tubular reactor produced ethylene/alkyl acrylate copolymers are distinguished from more conventional autoclave produced ethylene/alkyl acrylates. Thus the term or phrase “tubular reactor produced” ethylene/alkyl acrylate copolymer, for purposes of this invention, denotes an ethylene copolymer produced at high pressure and elevated temperature in a tubular reactor or the like, wherein the inherent consequences of dissimilar reaction kinetics for the respective ethylene and alkyl acrylate comonomers is alleviated or partially compensated by the intentional introduction of the monomers along the reaction flow path within the tubular reactor. As generally recognized in the art, such a tubular reactor copolymerization technique will produce a copolymer having a greater relative degree of heterogeneity along the polymer backbone (a more random distribution of comonomers), will tend to reduce the presence of long chain branching and will produce a copolymer characterized by a higher melting point than one produced at the same comonomer ratio in a high pressure stirred autoclave reactor.

Tubular reactor and autoclave processes are described in, e.g., “High Flexibility EMA Made From High Pressure Tubular Process”, Annual Technical Conference-Society of Plastics Engineers (2002), 60, vol. 2, 1832-1836.

As discussed above, epoxy functionalized ethylene copolymers, such as EnBAGMA, useful in the present invention and methods of employing the same, are known. These include, for example, copolymers and methods of use disclosed and taught in U.S. Pat. Nos. 5,306,750; 5,556,900; 6,011,095; 6,117,926; 6,414,056 and 6,399,680. The significant improvement in asphalt properties obtained by addition of the epoxy functionalized ethylene copolymers (e.g., EnBAGMA) in these prior compositions is believed due to a chemical reaction between the reactive copolymer additive and the functionalized polar fraction of asphalt referred to as asphaltenes. Acids, specifically superphosphoric acid (SPA) are currently used to enhance the performance of the epoxy functionalized ethylene copolymer when added to asphalt. Some improvements in asphalt properties can be obtained when epoxy containing reactive polymer additive is used without the addition of SPA, however the mixing time is very long (24+ hours vs. 3-6 hours with SPA) and the final asphalt properties are poorer. Thus, chemical bonding of the reactive epoxy functionalized ethylene copolymer to the asphalt produces a polymer-modified asphalt typically exhibiting one or more improved properties such as: improved dynamic shear rheometer stiffness values without appreciable loss in the G* viscous component of the complex modulus; improved low temperature creep stiffness and “m” value; higher temperature stiffness values for the ratio of the complex G* to the sin of the phase angle, (G*)/(sin δ), at 10 radian/sec; improved low phase angle and elastic recovery at 25° C. or the like.

Although the use of these ethylene copolymers as asphalt modifiers is known, it has now been found that the combination of the polymers with certain plastomers provides an asphalt modifier that has valuable properties in un-modified asphalt. By un-modified asphalt is meant that the asphalt does not contain additives such as acids or sodium hydroxide. An example of an un-modified asphalt is an Ardmore PG 58-28 un-modified grade produced at the Ardmore, Okla. refinery operated by Valero Inc.

Suitable plastomers for use in preparing the elastomer/plastomer compositions of the invention are low molecular weight polymeric or oligomeric waxes, such as polyolefin waxes, preferably polyethylene waxes. By low molecular weight is meant a weight average molecular weight of less than 7,000. Mixtures of plastomers are also suitable for use in the practice of the present invention. One preferable plastomer of note is a polyethylene wax that is a Fischer Tropsch wax supplied by Sasol Americas, Inc. Plastomers can be included in an amount of from about 0.01 to about 99.99 wt. % based on the total weight of the elastomer/plastomer composition. Preferably, however, from about 1 wt. % to 10 wt. % will be used. Most preferably, from about 1 wt. % to 5 wt. % will be used.

The elastomer component can be included in the elastomer/plastomer composition of the invention in amounts of from about 0.01 wt. % to about 99.99 wt. %, based on the total weight of the elastomer/plastomer composition. Preferably 90-99 wt. %, based on the total weight of the elastomer/plastomer composition, will be used. The elastomer/plastomer compositions of the invention may additionally comprise more than one of the above-described elastomers. Additionally other elastomers that are not EnBAGMA or ethylene alkyl acrylate copolymers obtained by a tubular reactor process may be present in the composition.

Benefits provided by the blending of the elastomer/low molecular weight plastomers of the invention with asphalt are that an acceptable performance grade (PG) can be obtained using less of the more expensive elastomeric composition; there is a significant reduction in viscosity of the resultant modified asphalt; faster dissolution of the modifying polymers in asphalt occurs, which can decrease cycle time; the stick temperature of the elastomer is raised when melt blended; and a mode of increasing R&B softening temperatures of elastomer modified asphalt is provided.

The elastomer/plastomer composition of the invention can be present in the asphalt in any effective amount, keeping the cost of materials in mind as a relevant factor. It is preferable that the elastomer blend (i.e. the combination of elastomer selected from the group consisting of ethylene/n-butyl acrylate/glycidyl methacrylate terpolymers, ethylene alkyl acrylate copolymers obtained by a tubular reactor process and mixtures thereof and plastomer) is present in the asphalt composition in an amount of from about 0.01 wt. % to about 25 wt. %, based on the total weight of the asphalt composition, preferably from about 1 wt. % to about 5 wt. %.

The elastomer/plastomer blend of the invention is preferably used as an additive for un-modified asphalt. Any such asphalt or bitumen material generally acknowledged as and/or used in road paving surfaces and similar roadway applications is suitable. As such, the terms asphalt and bitumen should be considered equivalent for purposes of this invention. Generally any natural occurring and/or synthetically manufactured asphalt or bitumen is suitable. Naturally occurring asphalts include by way of example but are not limited to such materials derived from native rock asphalt, lake asphalt, and the like. Synthetically manufactured asphalts typically include asphaltic by-products of petroleum refining operations and include air-blown asphalt, propane asphalt, straight-run asphalt, thermal asphalt and the like.

It should be appreciated that the use of other asphalt additives as generally practiced in asphalt road-surface paving applications may be optionally added as components of the polymer-modified asphalt compositions of the present invention. Thus the obvious use of aggregate with the polymer modified asphalt of the invention is contemplated. Also, the incorporation of an antistrip agent including those traditionally based on amine chemistry is also contemplated.

The method and sequence of steps employed to produce the polymer-modified asphalt blend comprising asphalt and the elastomer/plastomer blend of the invention can be by any of the methods and equipment as generally described in the prior art. However as a practical consideration, the addition of the elastomer/plastomer blend and the blending with the asphalt is most preferred particularly in conjunction with an already hot asphalt isolated/produced during oil refining operations.

The modified asphalt compositions of the invention are useful as pavements, for example as road and driveway paving material.

### EXAMPLES

### Example 1

A series of polymer-modified asphalt compositions of the invention was prepared by blending the elastomers and plastomers in the amounts shown in Table I with the asphalts shown. A total of 500 grams of each of the compositions (i.e. total weight of asphalt, elastomer and plastomer) were blended in 1000 ml open metal cans for 3 hours at 190° C. Mixing was carried out with a conventional 3-paddle air driven mixer. A control composition, which did not contain plastomer, was prepared using the same procedure. The compositions were then tested to determine properties important to asphalt. Results are shown in Table I and illustrate improved stiffness and improved elasticity in comparison to the unmodified asphalt. The un-modified asphalt has a phase angle of ˜87 degrees and elastic recovery of less than 10%. The compositions of the invention also exhibit lower viscosity vs. a modified asphalt not containing the low molecular weight plastomer. The Brookfield viscosity of modified asphalt not containing the plastomer is approximately 3000 cps. A description of the properties reported in Table I is found in the Detailed Description of the Invention above and ASTM D 6084.

TABLE I

| | | | | G*/sin d | | | |
|---|---|---|---|---|---|---|---|
| | | | G*/sin d | (original) | Phase | | Brookfield |
| | | | (original) | Pass/Fail | Angle | | Viscosity, |
| Asphalt | Elastomer | Plastomer | PG Grade | (=1.0 Mpa) | (original) | ER, 10° C. | cps@135° C. |
| Ardmore 58-28¹ | E/nBA² | Fischer Tropsch | 70 | 74.8 | 73.9 | 53 | 975 |
| (97 wt. %) | (2.7 wt. %) | wax³ | | | | | |
| | | (0.3 wt. %) | | | | | |
| Ardmore 58-28 | E/n-BA | Fischer Tropsch | 64 | 69 | 79.8 | 41 | 660 |
| (98.3 wt. %) | (1.53 wt. %) | wax | | | | | |
| | | (0.17 wt. %) | | | | | |
| Ardmore 58-28 | E/n-BA/GMA⁴ | Fischer Tropsch | 64 | 66.7 | 75.4 | 65 | 820 |
| (98.3 wt. %) | (1.53 wt. %) | wax | | | | | |
| | | (0.17 wt. %) | | | | | |
| Ardmore 58-2 | E/n-BA | Fischer Tropsch | 70 | 72.7 | 71.5 | 62 | 1090 |
| (97.5 wt. %) | (1.575 wt. %) | wax | | | | | |
| | E/n-BA/GMA⁵ | (0.25 wt. %) | | | | | |
| | (0.675 wt. %) | | | | | | |
| Ardmore 58-28 | E/n-BA/GMA⁴ | Fischer Tropsch | 70 | 71.7 | 75.5 | 62 | 814 |
| (98.09 wt. %) | (1.53 wt. %) | wax | | | | | |
| | | (0.38 wt. %) | | | | | |
| Conoco 58-28⁶ | E/n-BA⁷ | 0 wt. % | 76 | 76.9 | 69.2 | — | — |
| (95.5 wt. %) | (4.5 wt. %) | | | | | | |
| (Control) | | | | | | | |

¹Ardmore 58-28 - Asphalt produced at Ardmore, Okla. refinery of Valero Inc.
²Copolymer of ethylene and n-butyl acrylate, weight ratio 65:35, produced by a tubular reactor process
³Sasobit, a product of Sasol Americas, Inc.
⁴Copolymer of ethylene, butyl acrylate and glycidyl methacrylate, weight ratio 66.5:28:5.5
⁵Copolymer of ethylene, n-butyl acrylate and glycidyl methacrylate, weight ratio 66:22:12
⁶Conoco 58-28 - Asphalt produced by Conoco, Inc.
⁷Copolymer of ethylene and butyl acrylate, weight ratio 67:27, produced by a tubular reactor process

What is claimed is:

1. A composition useful as an asphalt modifier comprising an elastomer and a low molecular weight plastomer, wherein the elastomer is selected from the group consisting of ethylene/n-butyl acrylate/glycidyl methacrylate terpolymers, ethylene alkyl acrylate copolymers obtained by a tubular reactor process and mixtures thereof.

2. A composition of claim 1 wherein the elastomer is an ethylene/n-butyl acrylate terpolymer.

3. A composition of claim 1 wherein the elastomer is an ethylene alkyl acrylate copolymer obtained by a tubular reactor process.

4. A composition of claim 1 wherein the plastomer is present in the composition in an amount of from about 1 to about 5 wt.

5. A composition of claim 1 wherein the elastomer is an ethylene/n-butyl acrylate/glycidyl methacrylate terpolymer.

6. A polymer-modified asphalt composition comprising an un-modified asphalt, an elastomer and a low molecular weight plastomer, wherein the elastomer is selected from the group consisting of ethylene/n-butyl acrylate/glycidyl methacrylate terpolymers, ethylene alkyl acrylate copolymers obtained by a tubular reactor process and mixtures thereof.

7. A polymer-modified asphalt composition of claim 6 wherein the combination of a) ethylene/n-butyl acrylate/glycidyl methacrylate terpolymers, ethylene alkyl acrylate copolymers obtained by a tubular reactor process and mixtures thereof elastomer and b) plastomer is present in the asphalt composition in an amount of from about 0.01 wt. % to about 25 wt. %, based on the total weight of the polymer-modified asphalt composition.

8. A pavement comprising a polymer-modified asphalt composition wherein the asphalt composition comprises an un-modified asphalt, an elastomer and a low molecular weight plastomer, wherein the elastomer is selected from the group consisting of ethylene/n-butyl acrylate/glycidyl methacrylate terpolymers, ethylene alkyl acrylate copolymers obtained by a tubular reactor process and mixtures thereof.

9. A process for modifying an asphalt composition comprising the step of blending (i) a composition comprising an elastomer and a low molecular weight plastomer with (ii) an un-modified asphalt composition, wherein the elastomeric polymer is selected from the group consisting of ethylene/n-butyl acrylate/glycidyl methacrylate terpolymers, ethylene alkyl acrylate copolymers obtained by a tubular reactor process and mixtures thereof.
